(19) United States
(12) Patent Application Publication
(10) Pub. No.: US 2025/0021853 A1
(43) Pub. Date: Jan. 16, 2025

(54) REINFORCEMENT LEARNING BASED CLIFFORD CIRCUITS SYNTHESIS

(71) Applicant: International Business Machines Corporation, Armonk, NY (US)

(72) Inventors: Juan Cruz Benito, Salamanca (ES); David Kremer Garcia, Madrid (ES); Hanhee Paik, Danbury, CT (US); Ismael Faro Sertage, Chappaqua, NY (US); Ivan Duran Martinez, Elmsford, NY (US); Francisco Jose Martin Fernandez, Ridgefield, CT (US); Sanjay Kumar Lalta Prasad Vishwakarma, Sunnyvale, CA (US); Vipul Sharma, Toronto (CA)

(21) Appl. No.: 18/466,323

(22) Filed: Sep. 13, 2023

(30) Foreign Application Priority Data
Jul. 12, 2023 (EP) 23382712.0

(51) Int. Cl. G06N 10/20; G06N 20/00

(52) U.S. Cl. CPC G06N 10/20; G06N 20/00

(57) ABSTRACT

Systems and techniques that facilitate Clifford circuit synthesis are provided. For example, one or more embodiments described herein can comprise a system, which can comprise a memory that can store computer executable components. The system can also comprise a processor, operably coupled to the memory that can execute the computer executable components stored in memory. The computer executable components can comprise a receiver component that receives a quantum circuit design comprising a Clifford circuit representation and one or more circuit restrictions, and a machine learning component that generates, using a machine learning model, a replacement circuit based on the one or more circuit restrictions and the Clifford circuit representation, and generates a modified quantum circuit design by replacing the Clifford circuit representation with the replacement circuit.

### BACKGROUND

The subject disclosure relates to Clifford circuit synthesis, and more specifically, to reinforcement learning based synthesis of Clifford circuits.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate Clifford circuit synthesis.

According to an embodiment, a system can comprise a processor that executes computer executable components stored in memory. The computer executable components can comprise a receiver component that receives a quantum circuit design comprising a Clifford circuit representation and one or more circuit restrictions; and a machine learning component that generates, using a machine learning model, a replacement circuit based on the one or more circuit restrictions and the Clifford circuit representation, and generates a modified quantum circuit design by replacing the Clifford circuit representation with the replacement circuit.

According to another embodiment, a computer-implemented method can comprise receiving, by a system operatively coupled to a processor, a quantum circuit design comprising a Clifford circuit representation and one or more circuit restrictions; generating, by the system, using a machine learning model, a replacement circuit based on the one or more circuit restrictions and the Clifford circuit representation; and generating, by the system, a modified quantum circuit design by replacing the Clifford circuit representation with the replacement circuit.

According to another embodiment, a computer program product comprising a computer readable storage medium having program instructions embodied therewith, the program instructions executable by a processor to cause the processor to select, one or more gate options from a plurality of gate options; assign a penalty term to the selected one or more gate options; and select one or more additional gate options from the plurality of gate options based on the penalty term.

### DESCRIPTION OF THE DRAWINGS

FIGS. 1-2 illustrates block diagrams of example, non-limiting systems that can facilitate Clifford circuit synthesis in accordance with one or more embodiments described herein.

FIG. 3 illustrates a block diagram of a cloud inference and training system in accordance with one or more embodiments described herein.

FIG. 4 illustrates a block diagram of a local inference system in accordance with one or more embodiments described herein.

FIGS. 5-6 illustrate flow diagrams of example, non-limiting, computer implemented methods that facilitate synthesis of Clifford circuits in accordance with one or more embodiments described herein.

FIGS. 7A-D illustrate a flow diagram of an example, non-limiting, gate selection process in accordance with one or more embodiments described herein. in accordance with one or more embodiments described herein.

FIGS. 8-9 illustrate comparisons of transpilation outputs between the reinforcement learning method described herein and other quantum circuit transpiler in accordance with one or more embodiments described herein.

FIG. 10 illustrates an example of a target Clifford table and a generated plurality of possible replacement circuits in accordance with one or more embodiments described herein.

FIG. 11 illustrates an example, non-limiting environment for the execution of at least some of the computer code in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

In quantum computing, the Clifford group is a finite subgroup of the unitary group generated by the Hadamard, Controlled Not (CNOT) and S gates. The Clifford group plays a prominent role in quantum error correction, randomized benchmarking protocols and the general study of quantum entanglement. For example, the elements of the Clifford group can be used to perform magic state distillation. In practical applications, the ability to utilize Clifford group elements is dependent on the efficiency of circuit-level implementations, e.g., circuit length. Finding short circuits within the Clifford group is presently an issue, as despite the Clifford group being finite, its size grows quickly based on the number of qubits used in the quantum computing system. For example, with a system with six qubits, the number of Clifford group elements is approximately 2.1*10²³. Some existing Clifford circuit synthesis strategies largely relies on brute force, computing each Clifford group option and then storing the elements for later lookup. This approach can require large amounts of processing power as well as large amount of data storage, approximately 2 terabytes, thereby limiting the speed at which Clifford synthesis can be performed as well as limiting the types of computers capable of performing Clifford circuit synthesis. Furthermore, as the Clifford group elements increase as the number of qubits increases, as well as the computer storage requirements. Accordingly, database search methods are limited in the number of qubits that can be handled due to practical restrictions on computer memory usage.

In view of the problems discussed above, in relation to Clifford circuit synthesis, the present disclosure can be implemented to produce a solution to one or more of these problems by receiving a quantum circuit design comprising a Clifford circuit representation and one or more circuit restrictions, generating, using a machine learning model a replacement circuit based on the one or more circuit restrictions and the Clifford circuit representation, and generating a modified quantum circuit design by replacing the Clifford circuit representation with the replacement circuit. By utilizing a machine learning model, the storage requirements for a computer performing Clifford circuit synthesis can be greatly reduced, allowing for more computer systems to accurately and efficiently perform Clifford circuit synthesis.

In a further embodiment, generating the replacement circuit can comprise selecting one or more gate options from a plurality of gate options, assigning a penalty term to the selected one or more gate options, and selecting one or more additional gate options from the plurality of gate options based on the penalty term. In an embodiment, the penalty terms can be assigned based the one or more defined preferences and the Clifford circuit representation. Accordingly, larger penalty terms can be assigned to gate options that deviate from the one or more defined preferences, while lower penalty scores can be assigned based on compliance with the one or more preferences. For example, if the one or more defined preferences comprise a limit on a specific type of gate, then a large penalty can be assigned for selecting that specific gate types, while other gate types are assigned smaller penalties. In this embodiment, the machine learning model can comprise a reinforcement learning model, wherein the model receives a reward signal based on minimizing the cumulative penalty score of a generated replacement circuit. Accordingly, the reinforcement model can generate a Clifford circuit that complies with the one or more preferences by selecting gate options that lead to a relatively low cumulative penalty term. In an embodiment, the plurality of gate options can be limited by the one or more restrictions, and the one or more restrictions can comprise restrictions such as gate times, error rates, connectivity restrictions, and or other restrictions as specified by an entity.

In an additional embodiment, generating the replacement circuit can comprise generating a plurality of circuits, and then selecting the replacement circuit from the plurality of circuits based on the defined preferences. For example, the machine learning model can iterate N times to produce N possible circuits. In another embodiment, N machine learning models can operate in parallel to produce N circuits. Based, the defined preferences, one or more replacement circuits can be selected from the N possible circuits. For example, given a defined preference for a limited number of Controlled Not (CNOT) gates, the circuit with the fewest number of CNOT gates from the N possible circuits can be selected.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

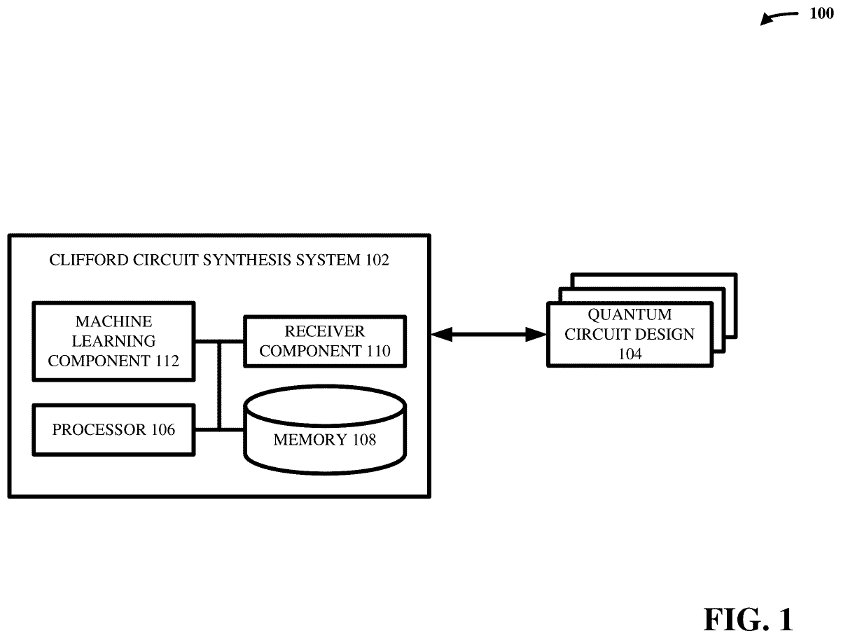

FIG. 1 illustrates block diagram of an example, non-limiting system 100 that can facilitate synthesis of Clifford circuits in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise receiver component 110, machine learning component 112, processor 106 and memory 108.

In various embodiments. Clifford circuit synthesis system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the Clifford circuit synthesis system 102 (e.g., receiver component 110 and/or machine learning component 112) to perform one or more acts. In various embodiments, the memory 108 can store computer-executable components (e.g., receiver component 110 and/or machine learning component 112), the processor 106 can execute the computer-executable components.

According to some embodiments, the machine learning component 112 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning component 112 can employ principles of probabilistic and decision theoretic inference to determine one or more responses based on information retained in a knowledge source database. In various embodiments, the machine learning component 112 can employ a knowledge source database comprising Clifford circuit previously synthesized by machine learning component 112. Additionally or alternatively, machine learning component 112 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects. Furthermore, the inference processes can be based on stochastic or deterministic methods, such as random sampling, Monte Carlo Tree Search, and so on.

The various aspects (e.g., in connection with automatic synthesis of Clifford circuits) can employ various artificial intelligence-based schemes for carrying out various aspects thereof. For example, a process for evaluating one or more gate options can be utilized to generate one or more Clifford circuits, without interaction from the target entity, which can be enabled through an automatic classifier system and process.

A classifier is a function that maps an input attribute vector, x=(x1, x2, x3, x4, xn), to a confidence that the input belongs to a class. In other words, f (x)=confidence (class). Such classification can employ a probabilistic and/or statistical-based analysis (e.g., factoring into the analysis utilities and costs) to prognose or infer an action that should be employed to make a determination. The determination can include, but is not limited to, whether to select a gate option from a plurality of gate options, and/or whether to select a generated Clifford circuit from a plurality of generated Clifford circuits.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM's can be configured through a learning phase or a training phase within a classifier constructor and feature selection module. Thus, a classifier(s) can be used to automatically learn and perform a number of functions, including but not limited to, synthesizing Clifford circuits based on Clifford group representations, circuit restrictions, and/or circuit preferences. Furthermore, one or more aspects can employ machine learning models that are trained utilizing reinforcement learning. For example, penalty/reward scores can be assigned for various gates selected by the machine learning component 112 based on one or more circuit restrictions and/or defined entity preferences. Accordingly, the machine learning component 112 can learn via selecting gate options with lower penalties and/or higher rewards in order to reduce an overall penalty score and/or increase an overall reward score.

In one or more embodiments, receiver component 110 can receive a quantum circuit representation and one or more circuit restrictions. In various embodiments, the quantum circuit representation can comprise a Clifford circuit representation (e.g., a Clifford circuit diagram), a Clifford table (e.g., a graphical representation of the Clifford table and qubit phase), and/or a circuit or portion of a circuit diagram to transform into a Clifford circuit (e.g., transpilation). Furthermore, the receiver component 110 can receive one or more circuit restrictions, and/or one or more defined preference metrics as defined by an entity. In an embodiment, the one or more circuit restrictions can comprise conditions that serve as limits or constraints for the generation of Clifford circuits. For example, the circuit restrictions can comprise restrictions such as capabilities of a quantum computer or quantum simulator, the number of number of qubits within a quantum computer or quantum simulator, quantum device topology, gate times, error rates, connectivity restrictions, time allowed for circuit synthesis, and/or other restrictions. In some embodiments, the circuit restrictions can also specify a specific machine learning model and/or type of machine learning model. For example, the restrictions can specify whether a stochastic or deterministic method is utilized. Accordingly, the circuit restrictions can serve as hard restraints for Clifford circuit synthesis (e.g., conditions that must be met or achieved). In various embodiments, the receiver component 110 can also receive defined preference metrics from an entity. The defined preference metrics can comprise preferences such as a number of Controlled Not (CNOT) gates, a number of circuit layers with CNOT gates, circuit length, circuit noise, a number of Clifford circuits to generate, and/or other defined entity preferences. As described below in greater detail, the defined preference metrics can be utilized as soft constraints (e.g., conditions that can be violated, but are reward for complying with).

In one or more embodiments, machine learning component 112 can generate one or more replacement circuits based on the one or more circuit restrictions and the Clifford circuit representation. For example, the quantum circuit design, the one or more circuit restrictions, and/or the one or more defined performance metrics can be utilized by a machine learning model to generate one or more Clifford circuits. In an embodiment, the machine learning component 112 can comprise multiple machine learning models. For example, the machine learning component 112 can comprise multiple machine learning models of the same type, to enable parallel or simultaneous generation of multiple Clifford circuit representations. In another example, the machine learning component 112 can comprise different types of machine learning models. For example, different machine learning models can be optimized for different quantum device restrictions, device topologies and/or specific quantum hardware or specific quantum simulators. Accordingly, machine learning component 112 can select an appropriate machine learning model based on the one or more circuit restrictions and/or defined entity preferences.

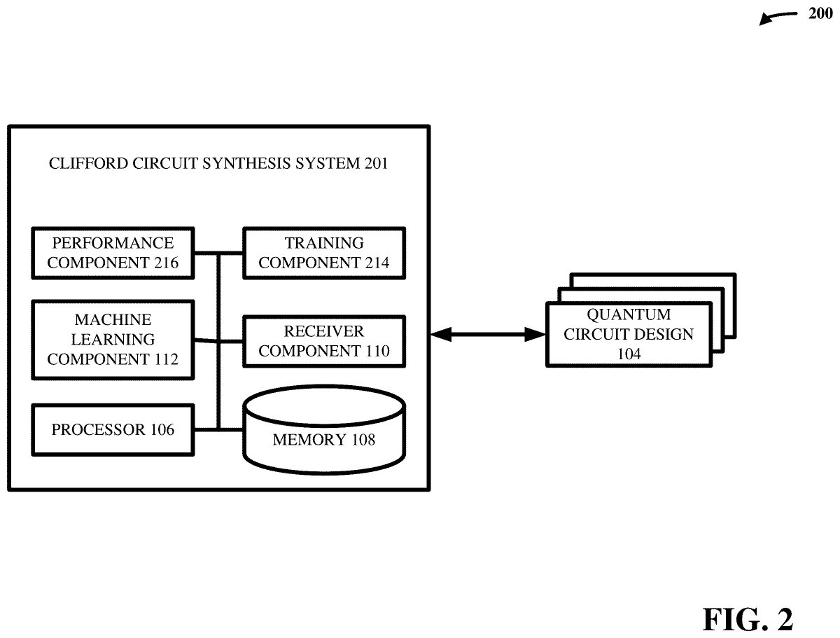

Once a machine learning model has been selected by machine learning component 112, the machine learning model can use the quantum circuit design, one or more circuit restrictions, and/or one or more defined entity preferences as input for an inference process. For example, the selected machine learning model can perform an inference process based on reinforcement learning, wherein actions taken during the inference process receive a penalty score based on the action. In an embodiment, the penalty score can comprise a negative value for a negative action, a zero for a neutral action, or a positive score for a positive action. A positive score can alternatively be referred to as a reward or reward score. Once the inference process is complete, the cumulative penalty score of all the actions can be utilized to represent how effective the inference process was. For example, a higher score can represent a good outcome, while a comparatively lower score can represent a worse outcome. For example, based on the circuit restrictions, the defined preferences, and the Clifford circuit representation, the machine learning component 112 can provide the selected machine learning model with a plurality of possible gate options. The machine learning model can then select a gate option from the plurality of gate options based on attempting to achieve the representation of the Clifford circuit and a penalty term can be assigned based on the selected gate and the defined entity preferences. For example, if the defined entity preferences comprise a limit on the number of CNOT gates, then penalty with a large negative term can be awarded in order to prevent the machine learning model from selecting a large number of CNOT gates, while a non-CNOT gate may be awarded a less negative penalty score or a neutral score. In another embodiment, penalty scores can be assigned based on the complexity of the gate or the number of qubits the gate acts on. For example, a gate that acts on multiple qubits can be assigned a larger negative penalty, while a gate that acts on a single qubit can be assigned a relatively smaller negative penalty. Based on the penalty score, the machine learning model can select an additional gate option from the plurality of gate options. For example, after selecting a gate option with a large negative value penalty score, the machine learning model can prioritize an additional gate option with a less negative score. In another example, if the machine learning model selects a gate option that causes the replacement circuit to match the Clifford circuit, then a large positive reward term can be assigned. Once the replacement circuit has been generated, a cumulative penalty score can be determined based on a summation of the penalty scores of the gates that were selected. As described in greater detail below in regard to FIG. 2, the cumulative penalty score can be utilized to retrain the machine learning model.

In an embodiment, machine learning component 112 can generate multiple replacement circuits. For example, the selected machine learning model of machine learning component 112 can generate a plurality replacement circuits through multiple iterations. In another example, multiple machine learning model of machine learning component 112 can operate in parallel or simultaneously to produce the plurality of possible replacement circuits. Once the plurality of possible replacement circuits is generated, then the machine learning component 112 can output the multiple replacement circuits to an entity for the entity to select a preferred replacement circuit. In another example, the machine learning component 112 can select a replacement circuit from the plurality of replacement circuits based on the defined preference metrics. For example, if the defined preference metrics comprise a preference for a limited number of CNOT gates, or a limited number of gate layers, then the machine learning component 112 can select the replacement circuit with the fewest CNOT gates or the fewest gate layers from the plurality of possible replacement circuits. In another embodiment, the machine learning component 112 can select multiple replacement circuits from the plurality of possible replacement circuits. For example, based on entity input to select N number of circuits, the machine learning component 112 can select N circuits from the plurality of possible replacement circuits based on the defined preference metrics. Alternatively, the circuit with the highest cumulative score can be selected and output. It should be appreciated that while examples of defined preference metrics are provided herein, use of any metric related to the layout of a circuit and/or circuit performance is envisioned.

In an embodiment, the number of circuits within the plurality of possible replacement circuits can be based on a circuit restriction input by an entity. For example, the circuit restrictions may comprise instructions to generate N circuits, wherein the machine learning component 112 will iterate N times to produce N circuits. In another example, the circuit restrictions may comprise a time limit, wherein the machine learning component 112 will continuously generate possible replacement circuits until the time limit is reached. Once a replacement circuit has been generated and selected, machine learning component 112 can generate a modified quantum circuit, by replacing the Clifford circuit representation of the quantum circuit with the generated replacement circuit. For example, the portion of the quantum circuit design comprising the Clifford circuit representation can be removed from the quantum circuit design and replaced with the replacement circuit. The modified quantum circuit can then be sent to a quantum computer or to a quantum simulator to be run.

FIG. 2 illustrates block diagram of an example, non-limiting system 200 that can facilitate synthesis of Clifford circuits in accordance with one or more embodiments described herein. Repetitive description of like elements employed in other embodiments described herein is omitted for sake of brevity.

As shown, Clifford circuit synthesis system 201 further comprises a performance component 216, and a training component 214. In an embodiment, training component 214 can perform a training process to initialize the machine learning models of machine learning component 112 utilizing reinforcement learning. Reinforcement learning operates based on assigning penalty or reward scores to actions taken by a machine learning model, wherein the machine learning model is trained to maximize a reward or positive score and minimize a penalty or negative score. Once an output has been scored, the machine learning model can be trained utilizing high scoring outputs as examples of correct outputs and low scoring outputs as examples of incorrect outputs. Therefore, the machine learning model is trained to generate outputs that attempt to increase or maximize a reward score. Accordingly, during a training process, a machine learning model can be trained to generate outputs that have scored highly and avoid outputs that would score poorly. In this manner, reinforcement learning can be utilized to balance the issue of exploration and exploration cost. As described above in relation to FIG. 1, machine learning component 112 can assign cumulative penalty scores to generated replacement circuits based on penalty scores for individual gates selected during a circuit generation process. Accordingly, training component 214 can train one or more machine learning models of machine learning component 112 by providing machine learning component 112 with Clifford tables to generate replacement circuits from, and then updating the training of the relevant machine learning model based on cumulative penalty score of the generated replacement circuit.

In an embodiment, performance component 216 can determine a performance metric between the quantum circuit design and the modified quantum circuit design comprising a generated replacement circuit. For example, once a modified quantum circuit design has been generated, performance component 216 can run both the quantum circuit design and the modified quantum circuit design on a quantum computer comprising physical qubits or on a quantum simulator to compare a performance metric between the two circuits. The performance metric can comprise any metric related to quantum circuits, such as but not limited to, gate connectivity, gate noise, error rates, or other performance related metrics. If the modified quantum circuit design has improved performance metrics compared to the original quantum circuit design, then the modified quantum circuit design can be sent to the training component 214 and used as a positive example in order to retrain the machine learning models of the machine learning component 112, thereby improving the performance metric of replacement circuits generated in the future. Alternatively, if the modified quantum circuit design has decreased performance metrics compared to the original quantum circuit design, then the modified quantum circuit design can be sent to the training component 214 and used as a negative example in order to retrain the machine learning models of the machine learning component 112.

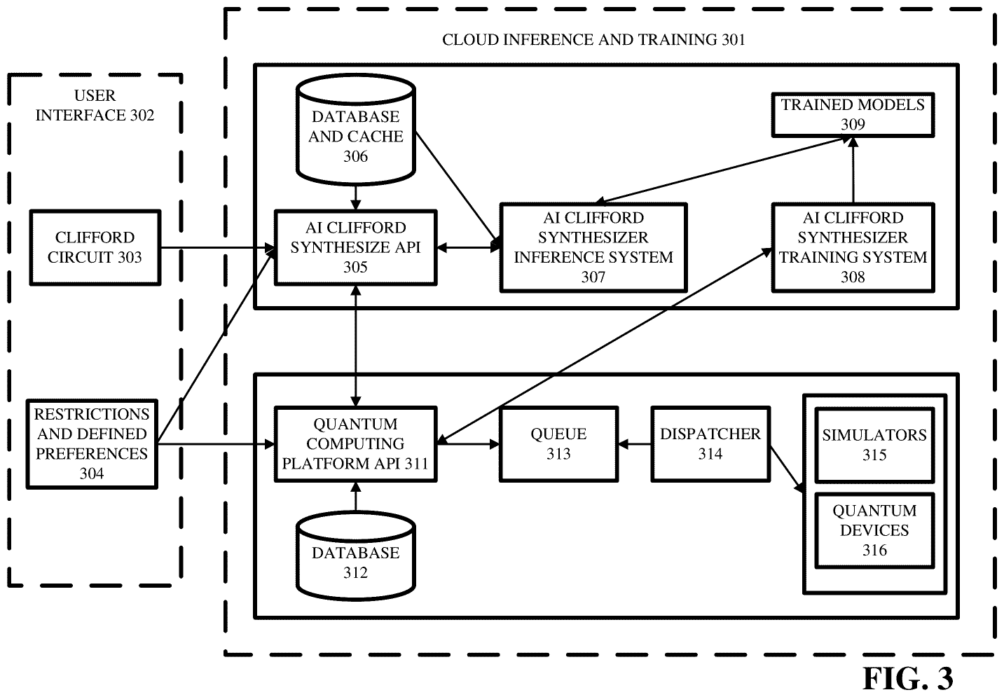

FIG. 3 illustrates a block diagram of cloud inference and training system 301 in accordance with one or more embodiments described herein. Repetitive description of like elements employed in other embodiments described herein is omitted for sake of brevity.

As shown, an entity can utilize user interface 302 to input Clifford circuit representation 303 and circuit restrictions and defined preferences 304. The Clifford circuit representation 303 and the restrictions and defined preferences 304 can be sent to the AI Clifford synthesizer application programing interface (API) 305 and the restrictions and defined preferences 304 can additionally be sent to quantum computing platform API 311. As described above in reference to machine learning component 112 of FIGS. 1 and 2, AI Clifford synthesizer inference system 307 can select one or more machine learning models of trained models 309 and utilize the one or more machine learning models to generate a replacement circuit and modified quantum circuit based on the Clifford circuit representation 303 and the restrictions and defined preferences 304. The modified quantum circuit can then be sent to Quantum computing platform API 311 via AI Clifford synthesize API 305. Quantum computing platform API 311 can then send the modified quantum circuit to queue 313 and to dispatcher 314, which can run the modified quantum circuit on either quantum devices 316 or on quantum simulator 315. Based on the performance of the modified quantum circuit when run, quantum computing platform API 311 can send the modified quantum circuit to AI Clifford synthesizer training system 308 in order to utilize the modified quantum circuit to retrain one or more models of the trained models 309.

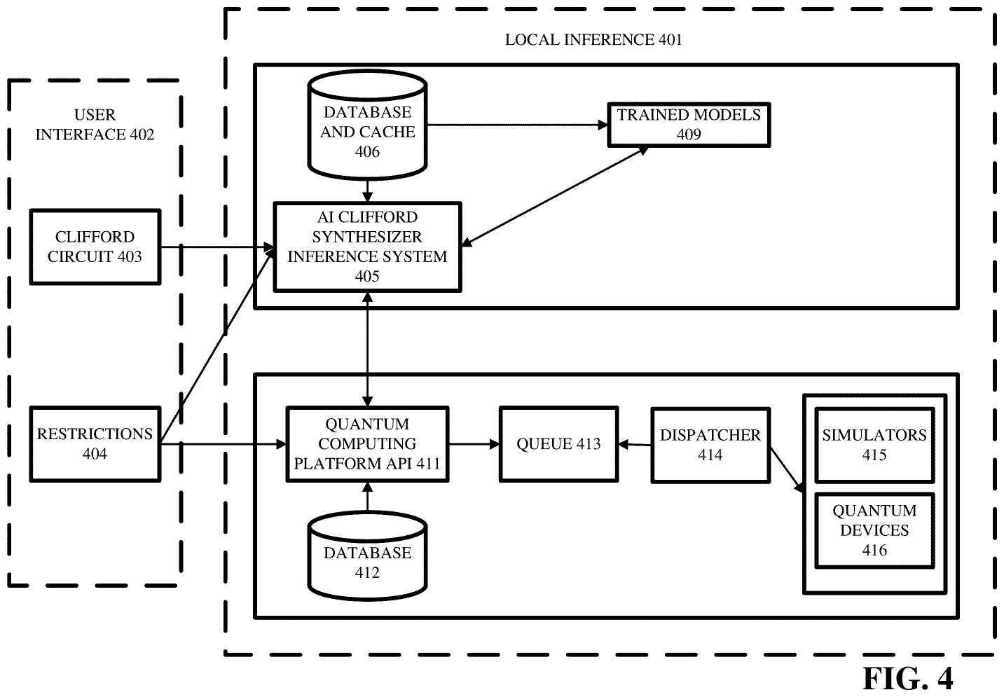

FIG. 4 illustrates a block diagram of a local inference system 401 in accordance with one or more embodiments described herein. Repetitive description of like elements employed in other embodiments described herein is omitted for sake of brevity.

As shown, an entity can utilize user interface 402 to input Clifford circuit representation 403 and circuit restrictions and defined preferences 404. The Clifford circuit representation 403 and the restrictions and defined preferences 404 can be sent to the AI Clifford synthesizer inference system 405 and the restrictions and defined preferences 304 can additionally be sent to quantum computing platform API 411. As described above in relation to machine learning component 112 of FIGS. 1 and 2, AI Clifford synthesizer inference system 405 can select one or more machine learning models of trained models 409 and utilize the one or more machine learning models to generate a replacement circuit and modified quantum circuit based on the Clifford circuit representation 403 and the restrictions and defined preferences 404. The modified quantum circuit can then be sent to Quantum computing platform API 411. Quantum computing platform API 411 can then send the modified quantum circuit to queue 413 and to dispatcher 414, which can run the modified quantum circuit on either quantum devices 416 or on quantum simulator 415.

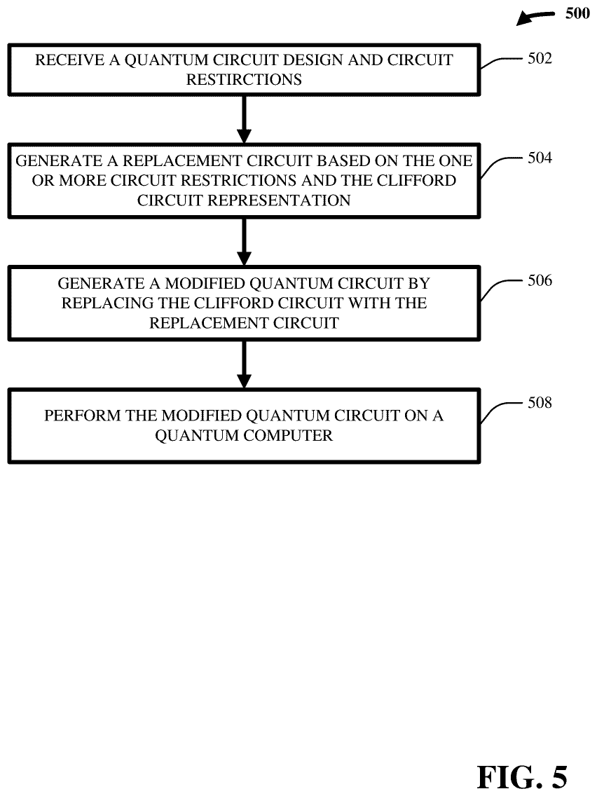

FIG. 5 illustrates a flow diagram of an example, non-limiting, computer implemented method 500 that facilitates synthesis of Clifford circuits in accordance with one or more embodiments described herein. Repetitive description of like elements employed in other embodiments described herein is omitted for sake of brevity.

At 502, method 500 can comprise receiving, by system (e.g., Clifford circuit synthesis system 102 and/or receiver component 110) operatively coupled to a processor (e.g., processor 106), a quantum circuit design and one or more restrictions. As described in greater detail above in reference to FIGS. 1 and 2, the one or more restrictions can comprise gate times, error rates or connectivity restrictions, and the quantum circuit design can comprise a Clifford circuit representation. The quantum circuit representation can comprise a Clifford circuit representation (e.g., a Clifford circuit diagram), a Clifford table (e.g., a graphical representation of the Clifford table and qubit phase), and/or a circuit or portion of a circuit diagram to transform into a Clifford circuit (e.g., transpilation).

At 504, method 500 can comprise generating, by the system (e.g., machine learning component 112), a replacement circuit based on the one or more restrictions and the Clifford circuit representation. As described above in greater detail in reference to FIGS. 1 and 2, the replacement circuit have a phase graph that is identical to the phase graph of the Clifford circuit representation.

At 506, method 500 can comprise generating, by the system (e.g., machine learning component 112), a modified quantum circuit by replacing the Clifford circuit with the replacement circuit.

At 508, method 500 can comprise performing, by the system (e.g., quantum simulators 315 and/or quantum devices 316) the modified quantum circuit on a quantum computer. For example, the modified circuit can by performed on quantum simulators or quantum hardware. By generating the modified quantum circuit by replacing the Clifford circuit with the replacement circuit as described above in reference to FIGS. 1 and 2, the amount of time to produce and execute the quantum circuits is decreased as transpiration time is decreased, while accuracy of the generated circuits is maintained or improved, thereby providing a practical improvement in performance of systems executing quantum circuits and quantum computing.

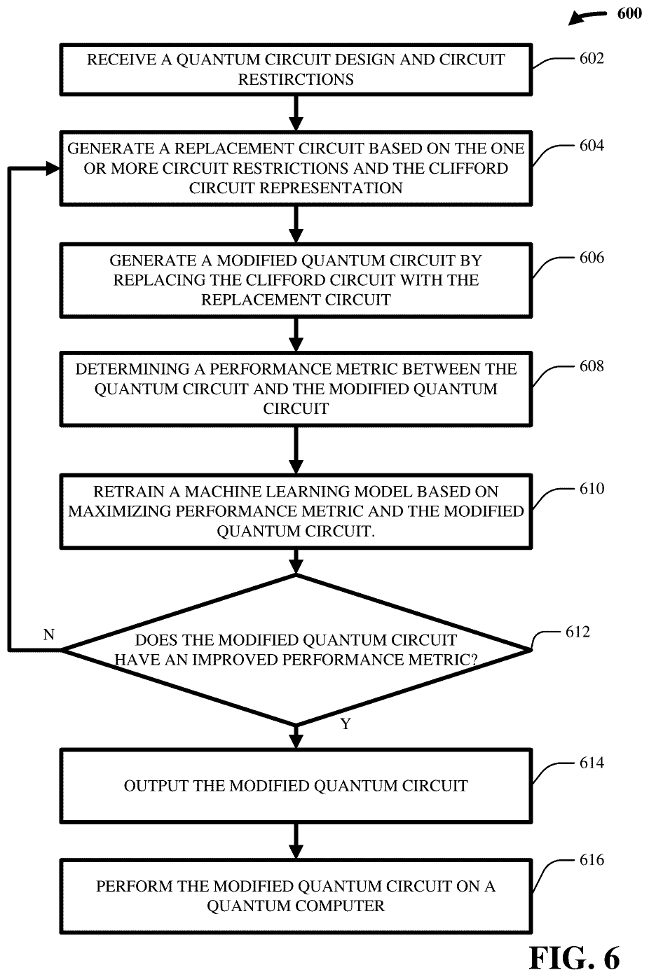

FIG. 6 illustrates a flow diagram of an example, non-limiting, computer implemented method 600 that facilitates synthesis of Clifford circuits in accordance with one or more embodiments described herein. Repetitive description of like elements employed in other embodiments described herein is omitted for sake of brevity.

At 602, method 600 can comprise receiving, by system (e.g., Clifford circuit synthesis system 102 and/or receiver component 110) operatively coupled to a processor (e.g., processor 106), a quantum circuit design and one or more restrictions. As described in greater detail above in reference to FIGS. 1 and 2, the one or more restrictions can comprise gate times, error rates or connectivity restrictions, and the quantum circuit design can comprise a Clifford circuit representation. The quantum circuit representation can comprise a Clifford circuit representation (e.g., a Clifford circuit diagram), a Clifford table (e.g., a graphical representation of the Clifford table and qubit phase), and/or a circuit or portion of a circuit diagram to transform into a Clifford circuit (e.g., transpilation).

At 604, method 600 can comprise generating, by the system (e.g., machine learning component 112), a replacement circuit based on the one or more restrictions and the Clifford circuit representation. As described above in greater detail in reference to FIGS. 1 and 2, the replacement circuit have a phase graph that is identical to the phase graph of the Clifford circuit representation.

At 606, method 600 can comprise generating, by the system (e.g., machine learning component 112), a modified quantum circuit by replacing the Clifford circuit with the replacement circuit.

At 608, method 600 can comprise determining, by the system (e.g., performance component 216), a performance metric between the quantum circuit and the modified quantum circuit. For example, as described above in reference to FIG. 2, the performance component 216 can run both the quantum circuit design and the modified quantum circuit design on either quantum hardware or a quantum simulator and compare the performance between the designs.

At 610, method 600 can comprise retraining, by the system, (e.g., training component 214), a machine learning model based on increasing the performance metric and the modified quantum circuit. For example, as described above in relation to FIG. 2, if the modified quantum circuit design has an improve performance metric when compared to the original quantum circuit design, then the modified quantum circuit design can be utilized as a positive training sample for retraining, otherwise, the modified quantum circuit design can be utilized as a negative sample for retraining.

At 612, if the modified quantum circuit has and an improved performance metric, method 600 can proceed to step 614 and output the modified quantum circuit design to an entity. If the modified quantum circuit does not have an improved performance metric, method 600 can return to step 604 to generate a new replacement circuit. In some embodiments, the modified quantum circuit design can be stored in a database for future use and/or lookup.

At 614, method 600 can comprise performing, by the system (e.g., quantum simulators 315 and/or quantum devices 316) the modified quantum circuit on a quantum computer. For example, the modified circuit can by performed on quantum simulators or quantum hardware. By generating the modified quantum circuit by replacing the Clifford circuit with the replacement circuit as described above in reference to FIGS. 1 and 2, the amount of time to produce and execute the quantum circuits is decreased as transpiration time is decreased, while accuracy of the generated circuits is maintained or improved, thereby providing a practical improvement in performance of systems executing quantum circuits and quantum computing.

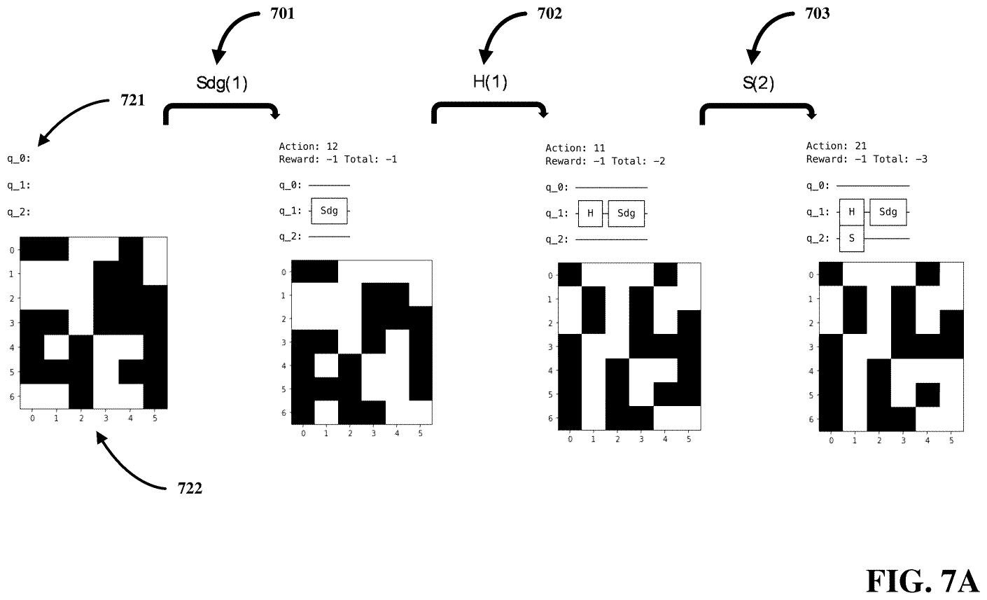

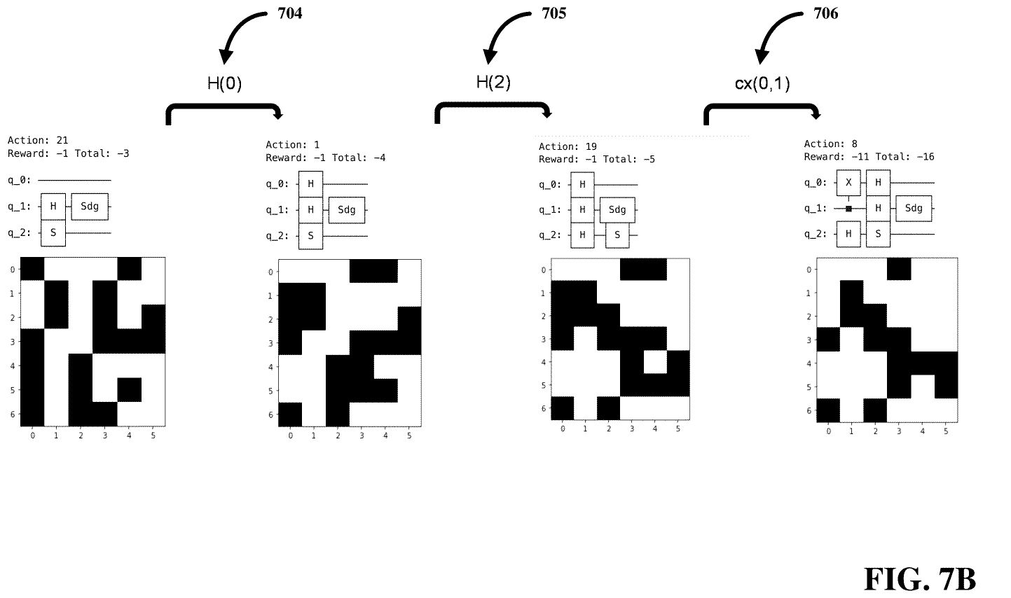

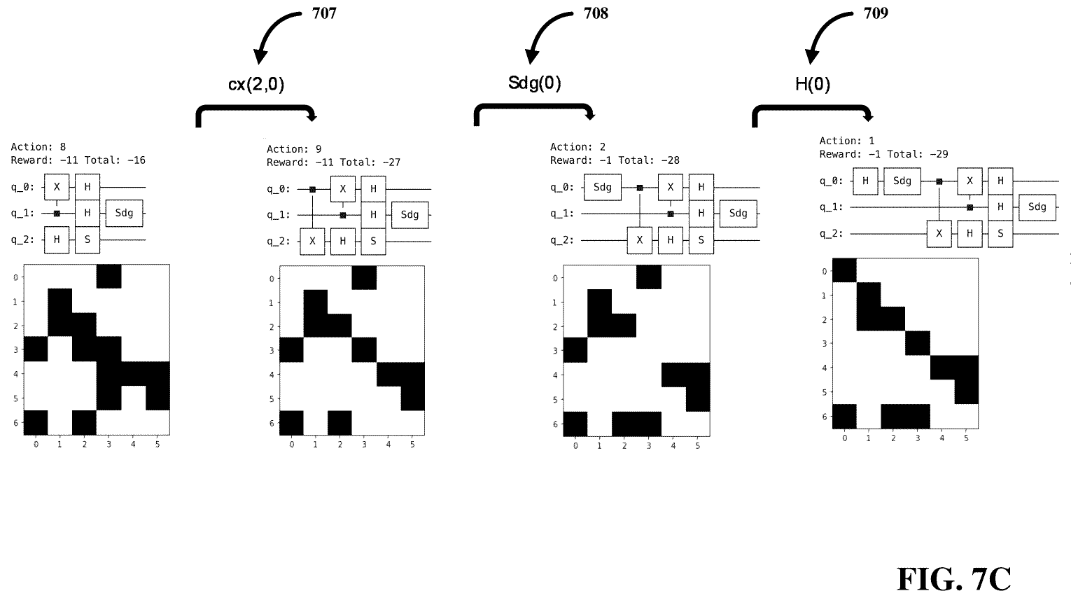

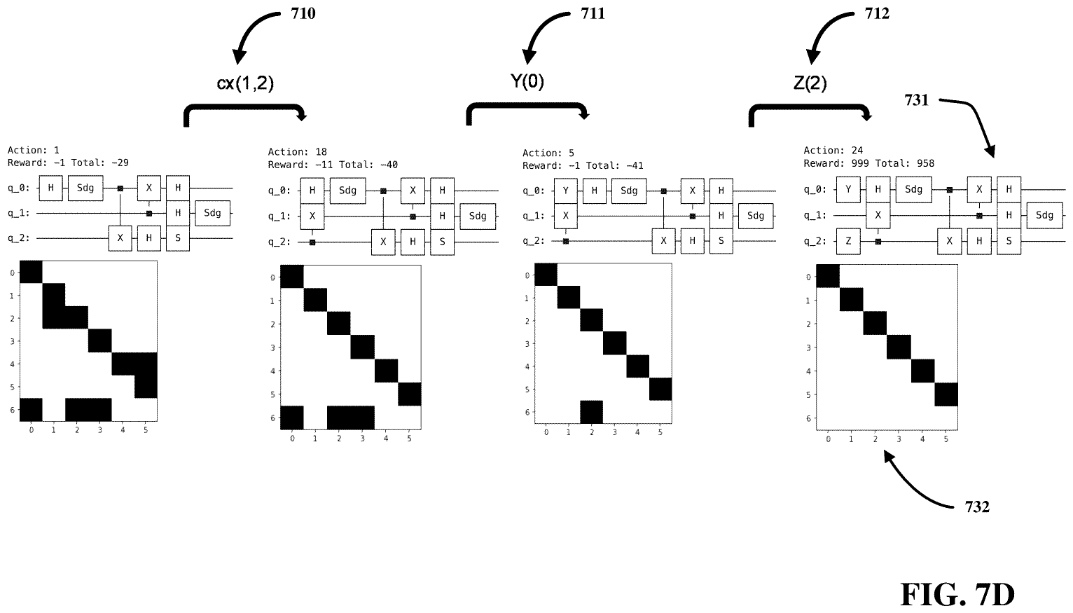

FIGS. 7A-D illustrate a flow diagram of an example, non-limiting, gate selection process in accordance with one or more embodiments described herein.

Graph 722 illustrates a graphical representation 722 of the phase of initial circuit diagram 721. As shown, initial circuit diagram 721 has no gates for qubits q_0, q_1, or q_2. As gates are selected the graphical representation and circuit diagram is updated accordingly. At step 701, an Sdg gate is selected for qubit q_1. As shown, the graphical representation is updated to reflect the changes caused by the Sdg gate, and the circuit diagram is updated to include an Sdg gate (e.g., a gate that induces a −π/2 phase) on qubit q_1. Based on the selection of the Sdg gate, a reward (e.g., penalty score) of −1 is assigned and the total (e.g., cumulative score) is updated to −1. At step 702, an H gate (e.g., Hadamard gate) is applied to qubit q_1. Based on the selection at step 702, a reward of −1 is assigned and the total is updated to −2. At 703, an S gate (e.g., a gate that induces a n/2 phase) is applied to qubit q_2, a reward score of −1 is assigned, and the total is updated to −3. At step 704, an H gate is applied to qubit q_0, a reward of −1 is assigned, and the total is updated to −3. At step 705, an H gate is applied to qubit q_2, a reward of −1 is assigned, and the total is updated to −4. At step 706, a cx (e.g., controlled X gate) is applied to qubits q_0 and q_1. As opposed to earlier steps, the cx gate is assigned a reward of −11, thereby having a larger negative impact on the total reward than other gate options. At step 707, a cx gate is applied to qubits q_2 and q_0, a reward of −11 is assigned, and the total is updated to −27. At step 708, an Sdg gate is applied to qubit q_0, a reward of −1 is assigned, and the total is updated to −28. At step 709, an H gate is applied to qubit q_0, a reward of −1 is assigned, and the total is updated to −29. At step 710, a cx gate is applied to qubits q_1 and q_2, a reward of −11 is assigned, and the total is updated to −40. At step 711, a Y gate (e.g., Pauli-Y gate) is applied to qubit q_0, a reward of −1 is assigned, and the total is updated to −41. At step 712, a Z gate (e.g., Pauli-Z gate) is applied to qubit q_2. At this step, as the updated graphical representation 731 matches an intended Clifford table, the circuit diagram 732 is considered finished and a reward of 999 is assigned based on completing the circuit diagram, and the total is updated to 958. As described in greater detail above in relation to FIG. 2, the reward score, and the circuit diagram can be used to retrain the machine learning model utilized to produce circuit diagram 732.

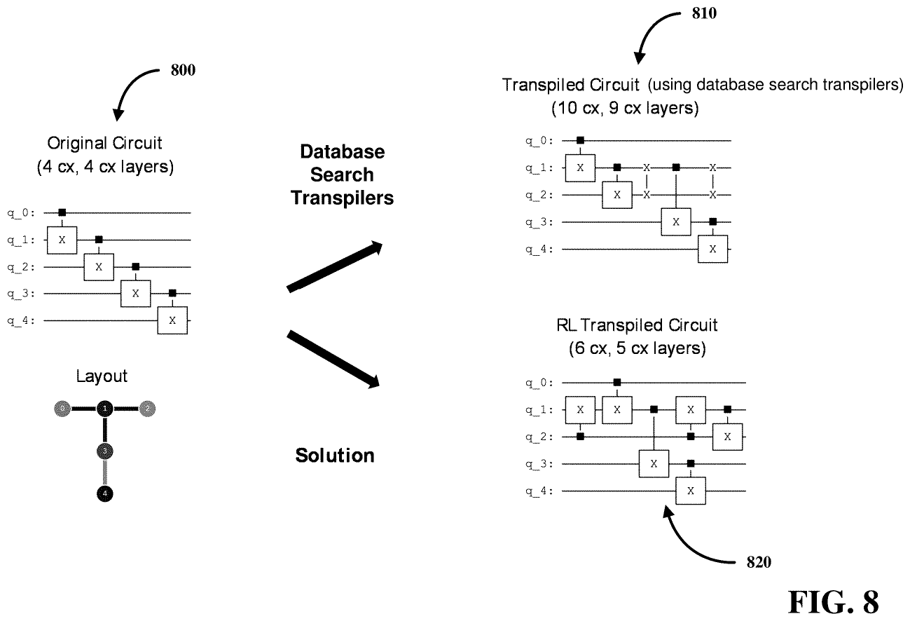

FIG. 8 illustrates a comparison of transpilation output between the reinforcement learning method described herein and other quantum circuit transpiler. Circuit diagram 800 illustrates a circuit that is to be transpiled into a Clifford circuit. Circuit diagram 810 illustrates the Clifford circuit generated using another quantum circuit transpiler and circuit diagram 820 illustrates the Clifford circuit generated using the Clifford circuit synthesis methods described herein. As shown, circuit 820 has decreased number of cx gates and cx layers in comparison to circuit 810.

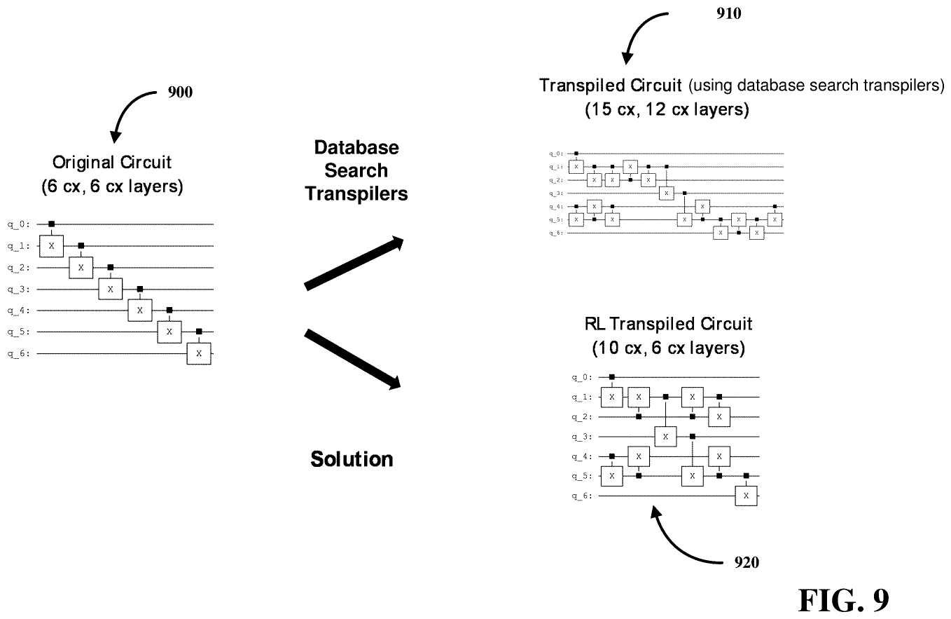

FIG. 9 illustrates a comparison of transpilation output between the reinforcement learning method described herein and other quantum circuit transpiler. Circuit diagram 900 illustrates a circuit that is to be transpiled into a Clifford circuit. Circuit diagram 910 illustrates the Clifford circuit generated using another quantum circuit transpiler and circuit diagram 920 illustrates the Clifford circuit generated using the Clifford circuit synthesis methods described herein. As shown, circuit 920 has decreased number of cx gates and cx layers in comparison to circuit 910. By decreasing the number of gates utilized, the Clifford circuit can be performed in less time, thereby improving performance of a quantum computing system utilized to execute the Clifford circuits.

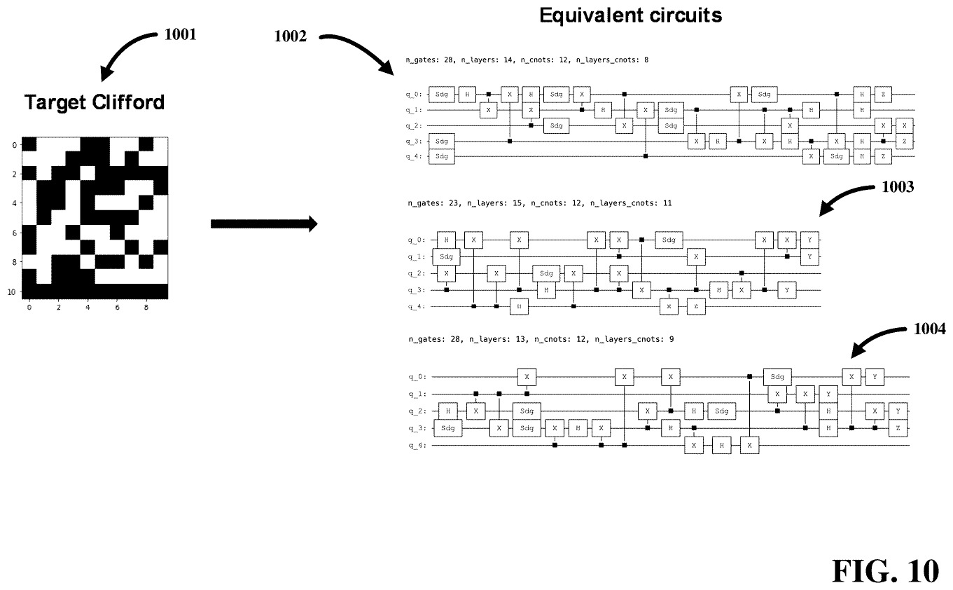

FIG. 10 illustrates an example of a target Clifford table and a generated plurality of possible replacement circuits in accordance with one or more embodiments described herein. As described above in reference to FIGS. 1 and 2, machine learning component 112 can generate a plurality of possible replacement circuits based on a Clifford circuit representation by iterating multiple times. For example, given the target Clifford circuit representation 1001, machine learning component 112 can iterate three times to produce replacement circuits, 1002, 1003, and 1404. As described above in relation to FIGS. 1 and 2, machine learning component 112 can provide replacement circuits 1002, 1003 and 1004 to an entity, or can select one or 1002, 1003 or 1004 as the replacement circuit based on a defined preference metric.

Clifford circuit synthesis system 102 can provide technical improvements to a processing unit associated with Clifford circuit synthesis system 102. For example, by utilizing reinforcement learning. Clifford circuit are synthesized faster, thereby reducing the workload of a processing unit (e.g., processor 106) that is employed to execute routines (e.g., instructions and/or processing threads) involved in synthesizing Clifford circuits. In this example, by reducing the workload of such a processing unit (e.g., processor 106), Clifford circuit synthesis system 102 can thereby facilitate improved performance, improved efficiency, and/or reduced computational cost associated with such a processing unit. Further, by utilizing a reinforcement learning model, instead of a large search database and search algorithms, the amount of memory storage utilized by Clifford circuit synthesis system 102 is reduced, thereby reducing the workload of a memory unit (e.g., memory 108) associated with Clifford circuit synthesis system 102. Clifford circuit synthesis system 102 can thereby facilitate improved performance, improved efficiency, and/or reduced computational cost associated with such a memory unit.

A practical application of Clifford circuit synthesis system 102 is that it allows for synthesis of Clifford circuits utilizing a reduced amount of computing and/or network resources, in comparison to other methods. For example, databases of Clifford circuits can utilize up to 2 TB of storage, thereby utilizing large memory requirements, which limits the types of computer systems capable of performing Clifford circuit synthesis. Furthermore, as the number of possible Clifford circuits grows in relation to the number of qubits for a quantum system, the storage requirements of Clifford circuit databases serve as a limit to the number qubits in quantum systems. By eliminating the requirement for Clifford circuit databases, Clifford circuit synthesis system 102 can enable synthesis of Clifford circuits for quantum systems with greater numbers of qubits. Clifford circuit synthesis system 102 can additionally produce circuits with a reduced number of gates, number of layers, number of CNOT gates, a number of layers with CNOTs in comparison to various other approaches. Therefore, Clifford circuit synthesis system 102 can enable generation of quantum circuits that can be operated with reduced quantum hardware requirements, thus promoting scalability of quantum systems. Furthermore, by reducing the number of gates within generated Clifford circuits while maintaining circuit accuracy, execution time of the Clifford circuits is thereby reduced, improving performance of quantum simulators and/or quantum computers utilized in executing the Clifford circuits.

It is to be appreciated that Clifford circuit synthesis system 102 can utilize various combination of electrical components, mechanical components, and circuitry that cannot be replicated in the mind of a human or performed by a human as the various operations that can be executed by Clifford circuit synthesis system 102 and/or components thereof as described herein are operations that are greater than the capability of a human mind. For instance, the amount of data processed, the speed of processing such data, or the types of data processed by Clifford circuit synthesis system 102 over a certain period of time can be greater, faster, or different than the amount, speed, or data type that can be processed by a human mind over the same period of time. According to several embodiments, Clifford circuit synthesis system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that Clifford circuit synthesis system 102 can include information that is impossible to obtain manually by an entity, such as a human user. For example, the type, amount, and/or variety of information included in Clifford circuit synthesis system 102 can be more complex than information obtained manually by an entity, such as a human user.

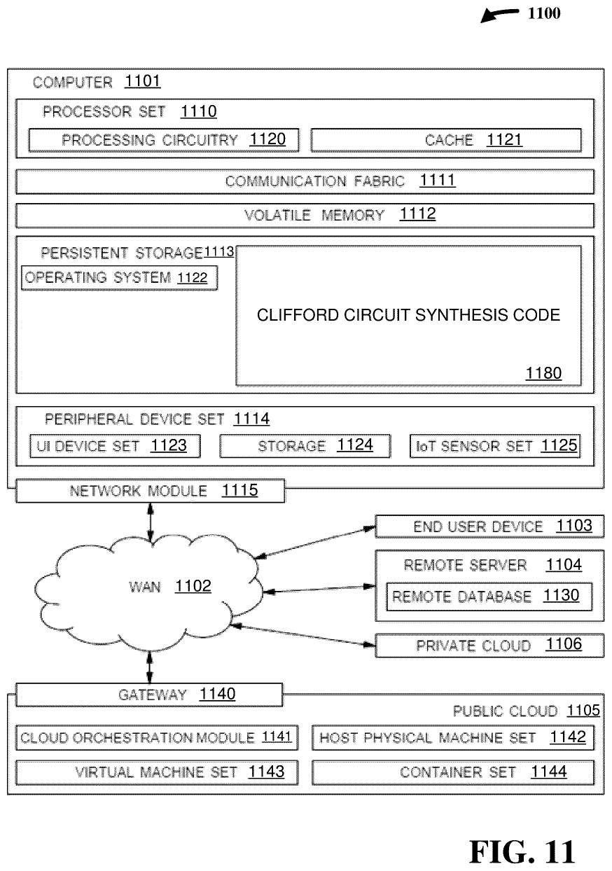

FIG. 11 and the following discussion are intended to provide a brief, general description of a suitable computing environment 1100 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the Clifford circuit synthesis code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

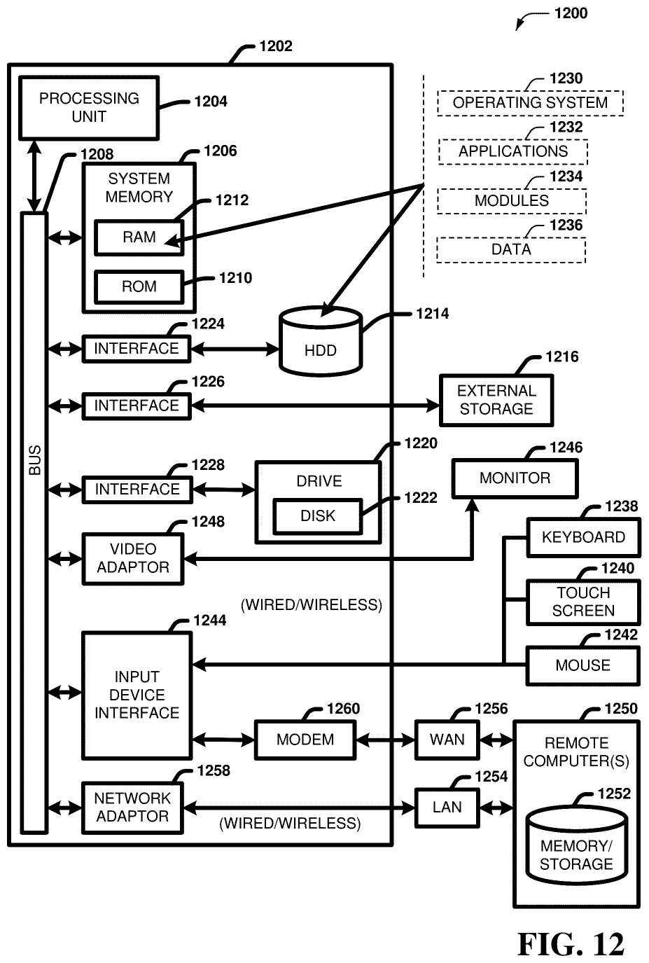

In order to provide a context for the various aspects of the disclosed subject matter, FIG. 12 as well as the following discussion are intended to provide a general description of a suitable environment in which the various aspects of the disclosed subject matter can be implemented. FIG. 12 illustrates a block diagram of an example, non-limiting operating environment in which one or more embodiments described herein can be facilitated. Repetitive description of like elements employed in other embodiments described herein is omitted for sake of brevity.

With reference to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and a drive 1220, e.g., such as a solid state drive, an optical disk drive, which can read or write from a disk 1222, such as a CD-ROM disc, a DVD, a BD, etc. Alternatively, where a solid state drive is involved, disk 1222 would not be included, unless separate. While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and drive 1220 can be connected to the system bus 1208 by an HDD interface 1224, an external storage interface 1226 and a drive interface 1228, respectively. The interface 1224 for external drive implementations can include at least one or both of Universal Serial Bus (USB) and Institute of Electrical and Electronics Engineers (IEEE) 1294 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1294 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above, such as but not limited to a network virtual machine providing one or more aspects of storage or processing of information. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A computer-implemented method comprising:
receiving, by a system operatively coupled to a processor, a quantum circuit design comprising a Clifford circuit representation and one or more circuit restrictions;
generating, by the system, using a machine learning model, a replacement circuit based on the one or more circuit restrictions and the Clifford circuit representation; and
generating, by the system, a modified quantum circuit design by replacing the Clifford circuit representation with the replacement circuit.

2. The computer-implemented method of claim 1, wherein the generating the replacement circuit comprises:
selecting, by the system, one or more gate options from a plurality of gate options;
assigning, by the system, a penalty term to the selected one or more gate options; and
selecting, by the system, one or more additional gate options from the plurality of gate options based on the penalty term.

3. The computer-implemented method of claim 1, wherein the generating the replacement circuit comprises:
generating, by the system, a plurality of circuits based on the Clifford circuit representation; and
selecting, by the system, the replacement circuit from the plurality of circuits based on a defined preference metric.

4. The computer-implemented method of claim 3, wherein the defined preference metric comprises at least one of a number of Controlled Not (CNOT) gates, a number of circuit layers with CNOT gates, circuit length or circuit noise.

5. The computer-implemented method of claim 1, further comprising:
determining, by the system, a performance metric between the quantum circuit design and the modified quantum circuit design based on a performance; and
retraining, by the system, the machine learning model based on maximizing the performance metric and the modified quantum circuit design.

6. The computer-implemented method of claim 1, wherein the machine learning model comprises a reinforcement learning model.

7. The computer-implemented method of claim 1, wherein the one or more circuit restrictions comprises gate times, error rates or connectivity restrictions.

8. A computer program product, the computer program product comprising a computer readable storage medium having program instructions embodied therewith, the program instructions executable by a processor to cause the processor to:
receive, by the processor, a quantum circuit design comprising a Clifford circuit representation and one or more circuit restrictions;
generate, by the processor, using a machine learning model, a replacement circuit based on the one or more circuit restrictions and the Clifford circuit representation; and
generate, by the processor, a modified quantum circuit design by replacing the Clifford circuit representation with the replacement circuit.

9. The computer program product of claim 8, wherein the generating the replacement circuit causes the processor to:
select, by the processor, one or more gate options from a plurality of gate options;
assign, by the processor, a penalty term to the selected one or more gate options; and
select, by the processor, one or more additional gate options from the plurality of gate options based on the penalty term.

10. The computer program product of claim 8, wherein the generating the replacement circuit causes the processor to:
generate, by the processor, a plurality of circuits based on the Clifford circuit representation; and
select, by the processor, the replacement circuit from the plurality of circuits based on a defined preference metric.

11. The computer program product of claim 10, wherein the defined preference metric comprises at least one of a number of Controlled Not (CNOT) gates, a number of circuit layers with CNOT gates, circuit length or circuit noise.

12. The computer program product of claim 8, wherein the program instructions further cause the processor to:
determine, by the processor, a performance metric between the quantum circuit design and the modified quantum circuit design; and
retraining, by the processor, the machine learning model based on maximizing the performance metric and the modified quantum circuit design.

13. The computer program product of claim 8, wherein the machine learning model comprises a reinforcement learning model.

14. The computer program product of claim 8, wherein the one or more circuit restrictions comprises gate times, error rates or connectivity restrictions.

15. A system comprising:
a memory that stores program instructions;
a processor that executes the program instructions stored in the memory, wherein executing the program instructions cause the system to:
receive a quantum circuit design comprising a Clifford circuit representation and one or more circuit restrictions; and
generate, using a machine learning model, a replacement circuit based on the one or more circuit restrictions and the Clifford circuit representation; and
generate a modified quantum circuit design by replacing the Clifford circuit representation with the replacement circuit.

16. The system of claim 15, wherein the generating the replacement circuit comprises:
selecting one or more gate options from a plurality of gate options;
assigning a penalty term to the selected one or more gate options; and
selecting one or more additional gate options from the plurality of gate options based on the penalty term.

17. The system of claim 15, wherein the generating the replacement circuit comprises:
generating a plurality of circuits based on the Clifford circuit representation; and
selecting the replacement circuit from the plurality of circuits based on a defined preference metric.

18. The system of claim 17, wherein the defined preference metric comprises at least one of a number of Controlled Not (CNOT) gates, a number of circuit layers with CNOT gates, circuit length or circuit noise.

19. The system of claim 15, wherein the computer executable components further comprise:
a performance component that determines a performance metric between the quantum circuit design and the modified quantum circuit design; and
a training component that retrains the machine learning component based on maximizing the performance metric and the modified quantum circuit design.

20. The system of claim 15, wherein the machine learning component comprises a reinforcement learning model.
